(19) United States
(12) Patent Application Publication
(10) Pub. No.: US 2026/0298162 A1
(43) Pub. Date: Oct. 1, 2026

(54) CONTROLLER FOR INTERNAL COMBUSTION ENGINE

(71) Applicant: TOYOTA JIDOSHA KABUSHIKI KAISHA, Toyota-shi (JP)

(72) Inventor: Yoichi TSUDA, Kakamigahara-shi (JP)

(21) Appl. No.: 19/393,602

(22) Filed: Nov. 19, 2025

(30) Foreign Application Priority Data
Mar. 28, 2025 (JP) 2025-056322

(51) Int. Cl. F02D 41/00

(52) U.S. Cl. CPC F02D 41/0002; F02D 2041/001; F02D 2200/10; F02D 2200/703

(57) ABSTRACT

An internal combustion engine includes an intake valve and an intake-side variable valve actuation mechanism configured to change a closing timing of the intake valve. The internal combustion engine is configured such that an early-closing control for closing the intake valve at a timing prior to an intake bottom dead center is executed. The controller includes processing circuitry. The processing circuitry is configured to set the closing timing of the intake valve based on an engine operating state and an atmospheric pressure.

### CROSS-REFERENCE TO RELATED APPLICATIONS

This application is based upon and claims the benefit of priority from Japanese Patent Application No. 2025-056322, filed on Mar. 28, 2025, the entire contents of which are incorporated herein by reference.

### BACKGROUND

### 1. Field

The present invention relates to a controller for an internal combustion engine.

### 2. Description of Related Art

As disclosed in JP2011-163135A, an internal combustion engine is known that performs an early-closing control in which the intake valve is closed at a timing prior to the intake bottom dead center. Compared with a late-closing control in which the intake valve is closed after the intake bottom dead center, the early-closing control reduces the backflow of intake air into the intake port. Consequently, the temperature within the cylinder is suppressed from rising, which is advantageous in preventing knocking. Accordingly, the early-closing control allows the ignition timing to be more advanced than in the late-closing control, thereby facilitating an increase in the engine output due to advancement of the ignition timing. However, in an internal combustion engine implementing the early-closing control, if the closing timing of the intake valve is set to a timing at which the intake air amount is maximized, the effective compression ratio increases, making knocking more likely to occur. In this case, in order to suppress knocking, the knock-limit ignition timing must be set to a retarded timing, which makes it difficult to increase engine output by advancing the ignition timing. Therefore, when early-closing control is performed, the closing timing of the intake valve is set with priority given to suppressing knocking rather than maximizing the intake air amount.

At high altitudes where the atmospheric pressure is low, it becomes more difficult for air to enter the cylinder. Therefore, when early-closing control is performed such that the closing timing of the intake valve is set to prioritize suppression of knocking rather than increasing the intake air amount, the intake air amount of the internal combustion engine may decrease, resulting in a reduction in engine output.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a controller for an internal combustion engine is provided. The internal combustion engine includes an intake valve and a variable valve actuation mechanism configured to change a closing timing of the intake valve. The internal combustion engine is configured such that an early-closing control for closing the intake valve at a timing prior to an intake bottom dead center is executed. The controller includes processing circuitry. The processing circuitry is configured to set the closing timing based on an engine operating state and an atmospheric pressure.

Other features and aspects will be apparent from the following detailed description, the drawings, and the claims.

### BRIEF DESCRIPTION OF THE DRAWINGS

FIG. 1 is a schematic diagram showing the configuration of an internal combustion engine according to one embodiment.

FIG. 2 is a flowchart showing a procedure of processes executed by a controller according to the embodiment.

FIG. 3 is a graph showing the relationship between the closing timing of the intake valve and the atmospheric pressure in the embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

A controller for an internal combustion engine according to one embodiment will now be described.

### Configuration of the Internal Combustion Engine

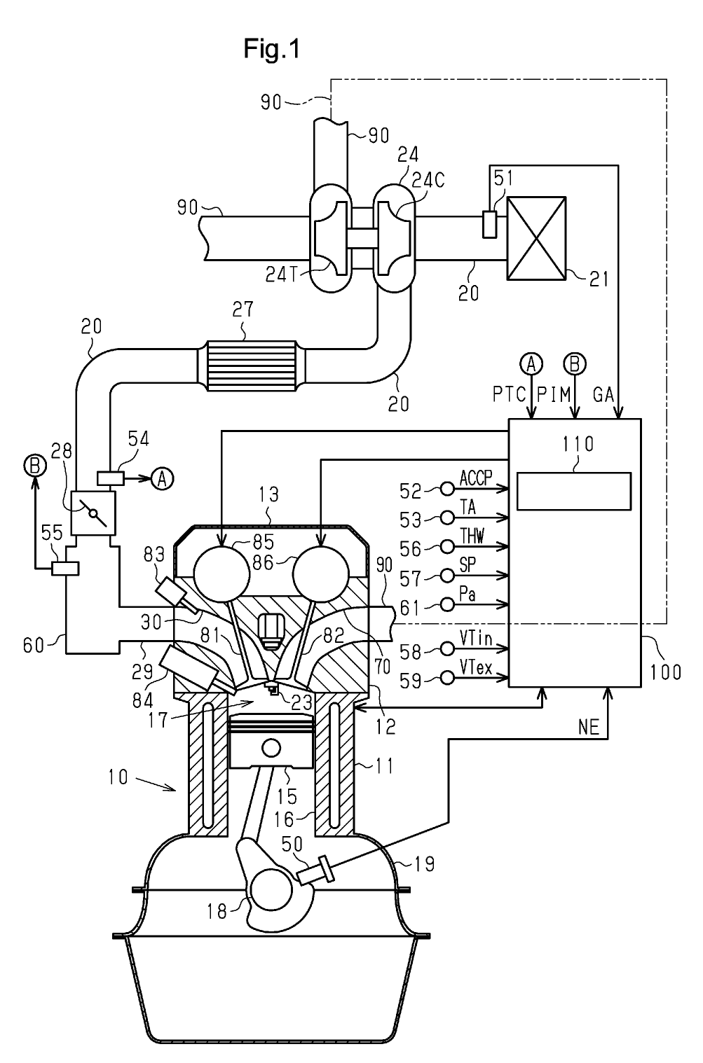

As shown in FIG. 1, the internal combustion engine 10 includes a cylinder block 11, a cylinder head 12, a head cover 13, and the like.

A cylinder 16 of the internal combustion engine 10 is provided in the cylinder block 11. A piston 15 is disposed in the cylinder 16.

The cylinder head 12 includes an intake port 30 that draws intake air into a combustion chamber 17 of the internal combustion engine 10 and an exhaust port 70 that discharges exhaust gas from the combustion chamber 17.

The intake port 30 includes an intake valve 81. The drive system of the intake valve 81 is provided with an intake-side variable valve actuation mechanism 85 that is a variable valve actuation mechanism that changes an opening timing and a closing timing that are valve timings of the intake valve 81.

An exhaust valve 82 is arranged in the exhaust port 70. A drive system of the exhaust valve 82 is provided with an exhaust-side variable valve actuation mechanism 86, which is a variable valve actuation mechanism that changes an opening timing and a closing timing, which are valve timings of the exhaust valve 82.

The internal combustion engine 10 includes a fuel injection valve that supplies fuel into a cylinder. For example, the internal combustion engine 10 includes a port injection valve 83 that injects fuel into the intake port 30, and an in-cylinder injection valve 84 that directly injects fuel into the combustion chamber 17. The cylinder head 12 is provided with an ignition plug 23.

A crankcase 19 is arranged below the cylinder block 11. The crankcase 19 accommodates a crankshaft 18, which is an output shaft of the internal combustion engine 10.

An intake manifold 29 including a surge tank 60 is connected to an upstream portion of the intake port 30. An intake pipe 20 is connected to an upstream portion of the surge tank 60. The intake pipe 20, the surge tank 60, the intake manifold 29, and the intake port 30 form an intake passage of the internal combustion engine 10.

The intake pipe 20 is provided with an air cleaner 21, an air flow meter 51, a compressor wheel 24C of a forced-induction device 24 that is driven using exhaust gas discharged from the combustion chamber 17, an intercooler 27, a boost pressure sensor 54, and a throttle valve 28 in this order from the upstream side. The surge tank 60 is provided with an intake pressure sensor 55. The opening degree of the throttle valve 28 is changed by an electric motor to adjust the intake air amount. Further, the smaller the opening degree of the throttle valve 28, the smaller the amount of air passing through the throttle valve 28.

The air cleaner 21 filters intake air drawn into the intake pipe 20. The forced-induction device 24 compresses air in the intake pipe 20. The intercooler 27 cools the air that has passed through the compressor wheel 24C. The open degree of the throttle valve 28 is adjusted to control the intake air amount.

The air flow meter 51 detects an intake air amount GA. The boost pressure sensor 54 detects a boost pressure PTC in a portion of the intake pipe 20 downstream of the compressor wheel 24C. The intake pressure sensor 55 detects an intake pressure PIM, which is the pressure in the surge tank 60. The intake pressure PIM is a pressure in the intake passage downstream of the throttle valve 28.

An exhaust passage 90 is connected to the downstream side of the exhaust port 70. A housing that accommodates a turbine wheel 24T of the forced-induction device 24 is connected to an intermediate portion of the exhaust passage 90.

The controller 100 operates various operation target devices such as the throttle valve 28, the port injection valve 83, the in-cylinder injection valve 84, the ignition plug 23, the intake-side variable valve actuation mechanism 85, and the exhaust-side variable valve actuation mechanism 86.

The controller 100 includes processing circuitry 110. The processing circuitry 110 includes a CPU that executes processing in accordance with a program, and a memory in which the program and various values are stored. The CPU executes a program stored in the memory to perform various controls.

Detection signals of the air flow meter 51, the boost pressure sensor 54, and the intake pressure sensor 55 are input to the controller 100. Further, detection signals of other various sensors are input to the controller 100. For example, the controller 100 receives a detection signal of an accelerator operation amount sensor 52 that detects an accelerator operation amount ACCP that is an operation amount of an accelerator pedal that adjusts the output of the internal combustion engine 10. The controller 100 also receives a detection signal of a throttle sensor 53 that detects a throttle opening degree TA that is an opening degree of the throttle valve 28. The controller 100 further receives a detection signal of a water temperature sensor 56 that detects a cooling water temperature THW, which is the temperature of cooling water of the internal combustion engine 10. The controller 100 also receives a detection signal of a crank angle sensor 50 that detects a rotation angle (crank angle) of the crankshaft 18 for calculating an engine rotation speed NE, and a detection signal of a vehicle speed sensor 57 that detects a vehicle speed SP of the vehicle. The controller 100 receives a detection signal of an atmospheric pressure sensor 61 that detects the atmospheric pressure Pa. Further, the controller 100 receives a detection signal of an intake side cam angle sensor 58 that detects an intake side valve timing VTin that is a valve timing of the intake valve 81. The controller 100 also receives a detection signal from an exhaust-side cam angle sensor 59 that detects an exhaust-side valve timing VTex, which is the valve timing of the exhaust valve 82.

The controller 100 calculates an engine load factor KL based on the engine rotation speed NE and the intake air amount GA. The engine load factor KL is a parameter that determines the amount of air filling the combustion chamber 17, and is the ratio of the inflow air amount per combustion cycle in one cylinder to a reference inflow air amount. The reference inflow air amount is variably set in accordance with the engine rotation speed NE.

The controller 100 calculates a required torque required for traveling of the vehicle based on the accelerator operation amount ACCP and the vehicle speed SP. Then, the controller 100 controls the required output Pe of the internal combustion engine 10 so as to ensure the required torque of the vehicle.

The controller 100 calculates an intake-side target value VTint which is a target valve timing of the intake valve 81 in order to execute the early-closing control for closing the intake valve 81 at a timing prior to the intake bottom dead center. After calculating the intake-side target value VTint, the controller 100 controls the drive of the intake-side variable valve actuation mechanism 85 so that the actual valve timing of the intake valve 81 coincides with the intake-side target value VTint. In the present embodiment, a state where the valve timing of the intake valve 81 is most retarded is set to an initial value of 0, and the valve timing of the intake valve 81 is controlled using an advance amount of the valve timing from the initial value.

The controller 100 calculates an exhaust-side target value VText, which is a target valve timing of the exhaust valve 82, based on the engine rotation speed NE, the engine load factor KL, and the like. Then, the controller 100 controls the driving of the exhaust-side variable valve actuation mechanism 86 such that the actual valve timing of the exhaust valve 82 coincides with the exhaust-side target value VText. In the present embodiment, the initial value is 0 when the valve timing of the exhaust valve 82 is most advanced. The controller 100 controls the valve timing of the exhaust valve 82 by using the retard amount of the valve timing from the initial value.

### Calculation of Intake-Side Target Value

The processing circuitry 110 sets the closing timing of the intake valve 81 based on the engine operating state and the atmospheric pressure. The processing circuitry 110 calculates the intake-side target value VTint in a process of setting the closing timing of the intake valve 81.

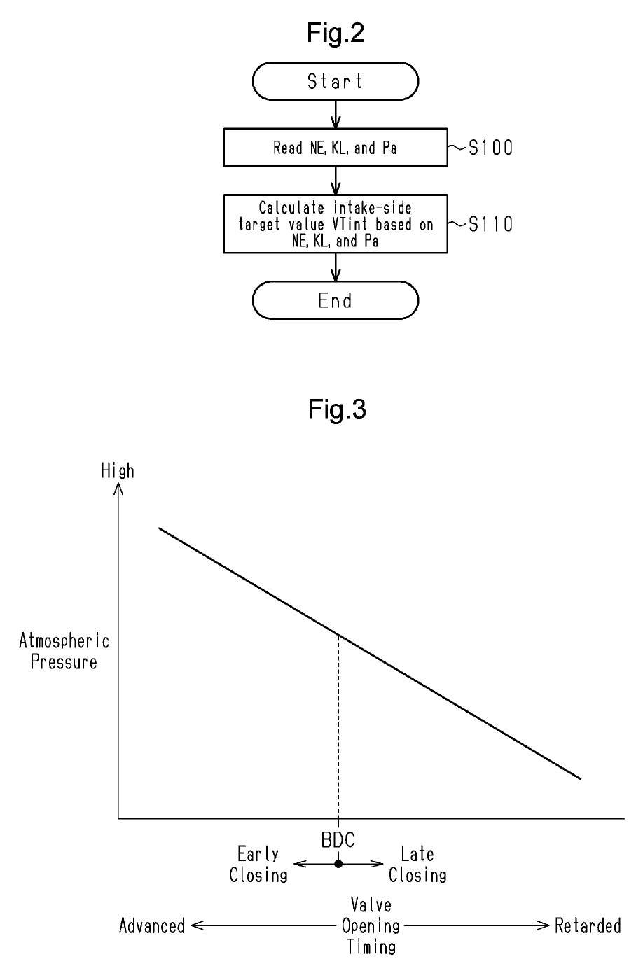

FIG. 2 shows a procedure of processes for calculating the intake-side target value VTint. The processing circuitry 110 executes the processes shown in FIG. 2 at specified execution cycles. In the following description, the number of each step is represented by the letter S followed by a numeral.

In the series of processes shown in FIG. 2, the processing circuitry 110 reads the current engine rotation speeds NE, the current engine load factor KL, and the current atmospheric pressure Pa (S100). The engine rotation speed NE and the engine load factor KL are both values indicating the current engine operating state.

Next, the processing circuitry 110 refers to a map prepared in advance to calculate the intake-side target value VTint based on the engine rotation speed NE, the engine load factor KL, and the atmospheric pressure Pa, which have been read in the process of S100 (S110). The calculation of the intake-side target value VTint based on the engine rotation speed NE and the engine load factor KL is known in the art. On the other hand, the calculation of the intake-side target value VTint based on the atmospheric pressure Pa is performed as follows.

As shown in FIG. 3, the processing circuitry 110 calculates the intake-side target value VTint such that the closing timing of the intake valve 81 becomes more retarded as the atmospheric pressure Pa decreases. In other words, when the atmospheric pressure Pa is relatively high, the processing circuitry 110 performs early closing of the intake valve 81 by calculating the intake-side target value VTint such that the closing timing of the intake valve 81 is more advanced than the intake bottom dead center BCD. Also, when the atmospheric pressure Pa is relatively low, the processing circuitry 110 performs late closing of the intake valve 81 by calculating the intake-side target value VTint such that the closing timing of the intake valve 81 is more retarded than the intake bottom dead center BCD. Regarding the closing timing of the intake valve 81 when the late closing is performed, it is desirable that the retarded amount from the intake bottom dead center BCD falls within a range in which a decrease in the intake air amount due to backflow is minimized. Further, the relationship between the closing timing of the intake valve 81 and the atmospheric pressure Pa does not necessarily have to be linear as shown in FIG. 3, and may be, for example, curved.

When the intake-side target value VTint is calculated in the process of S110, the processing circuitry 110 controls operation of the intake-side variable valve actuation mechanism 85 such that the calculated intake-side target value VTint and the actual valve timing of the intake valve 81 match each other.

Then, after executing the process of S110, the processing circuitry 110 terminates the execution of the process in the current execution cycle.

### Operation and Advantages of the Present Embodiment

(1) The processing circuitry 110 sets the closing timing of the intake valve 81 by calculating the intake-side target value VTint based on the engine rotation speed NE and the engine load factor KL, which indicate the engine operating state, and the atmospheric pressure Pa.

Therefore, as compared with a case in which the closing timing of the intake valve 81 is set based on the engine operating state, the closing timing of the intake valve 81 is set in consideration of the influence of the atmospheric pressure Pa on the intake air amount. This permits the engine output to be increased at high altitudes.

(2) In the process of setting the closing timing of the intake valve 81, the lower the atmospheric pressure Pa, the more retarded the closing timing of the intake valve 81 is set, as shown in FIG. 3.

Accordingly, the closing timing of the intake valve 81 in the intake stroke becomes more retarded as the atmospheric pressure Pa decreases. The intake air amount GA thus increases as the atmospheric pressure Pa decreases. This permits the engine output to be increased appropriately at high altitudes.

At high altitudes, the pressure within the exhaust passage 90 becomes lower than that in lowlands, where the atmospheric pressure is higher. As a result, the amount of internal EGR within the cylinder decreases. When the amount of the internal EGR in the cylinder decreases, the temperature within the cylinder is reduced, making knocking less likely. Accordingly, even when the closing timing of the intake valve 81 is retarded so that the intake air amount GA increases as the atmospheric pressure Pa decreases, the occurrence of knocking is still suppressed.

### Modifications

The above-described embodiment may be modified as follows. The above-described embodiment and the following modifications can be combined as long as the combined modifications remain technically consistent with each other.

The engine operating state when the intake-side target value VTint is calculated based on the engine operating state is the engine rotation speed NE and the engine load factor KL, but the engine operating state may be at least one of the engine rotation speed NE and the engine load factor KL.

Regarding the closing timing of the intake valve 81 set based on the atmospheric pressure Pa, the closing timing set to be most retarded may be the intake bottom dead center. In this case, it is advantageous in suppressing increase in the temperature within the cylinder due to backflow of the intake air.

The internal combustion engine 10 does not necessarily have to include the forced-induction device 24.

The internal combustion engine 10 may include one of the port injection valve 83 and the in-cylinder injection valve 84.

The intake-side variable valve actuation mechanism 85 may be a variable valve actuation mechanism capable of changing at least the closing timing of the intake valve 81.

The controller 100 is not limited to a device that includes a CPU and a memory module and executes software processing. For example, the controller 100 may include hardware circuits, for example, an application-specific integrated circuit (ASIC), dedicated to executing at least part of the processes executed by the software in the above-described embodiment. That is, the controller 100 may be modified as long as it includes processing circuitry that has any one of the following configurations (a) to (c). (a) Processing circuitry including at least one processor that executes all of the above-described processes according to programs and at least one program storage device such as a ROM that stores the programs. (b) Processing circuitry including at least one processor and at least one program storage device that execute part of the above-described processes according to the programs and at least one dedicated hardware circuit that executes the remaining processes. (c) Processing circuitry including at least dedicated hardware circuit that executes all of the above-described processes. The program storage device, which is a computer-readable medium, includes any type of medium that is accessible by a general-purpose computer or a dedicated computer.

What is claimed is:

1. A controller for an internal combustion engine, wherein
the internal combustion engine includes:
an intake valve; and
a variable valve actuation mechanism configured to change a closing timing of the intake valve,
the internal combustion engine is configured such that an early-closing control for closing the intake valve at a timing prior to an intake bottom dead center is executed,
the controller includes processing circuitry, and
the processing circuitry is configured to set the closing timing based on an engine operating state and an atmospheric pressure.

2. The controller for the internal combustion engine according to claim 1, wherein the processing circuitry is configured to set the closing timing such that the closing timing becomes more retarded as the atmospheric pressure decreases.

3. The controller for the internal combustion engine according to claim 1, wherein the engine operating state is at least one of an engine rotation speed and an engine load factor.
